(19) United States
(12) Patent Application Publication
(10) Pub. No.: US 2007/0090290 A1
(43) Pub. Date: Apr. 26, 2007

(54) Compact sample extraction and conditioning device for infrared carbon dioxide monitor for rebreather life support systems

(76) Inventor: Thomas Hadley Rose, Raleigh, NC (US)

Correspondence Address: Thomas Hadley Rose, 2116 Oakton Dr, Raleigh, NC, 27606, US

(21) Appl. No.: 11/242,999

(22) Filed: Oct. 4, 2005

(51) Int. Cl. G02F 1/01

(52) U.S. Cl. 250/330

(57) ABSTRACT

This invention allows an optical CO₂ monitor to be used in the breathing loop of a rebreather by lowering the dew point of the gas to prevent condensation within the walls of the sample chamber. Gas flow is induced by a combination of aspiration driven by constant or intermittent flow of oxygen, oxygen enriched gas, and/or diluent gases and/or the pressure differential on a Pitot tube in the breathing loop. Dewpoint reduction is accomplished by counter current flow of dry oxygen, oxygen enriched gas, and/or diluent gases flowing on one side of a naflon or other suitable membrane with the other side of the membrane exposed to the breathing loop. The sample may be extracted either from the scrubbers or from the exhaust line after the scrubber. In one embodiment of the invention, the amount of scrubber usage can be determined by measurement of the proportion of Carbon Dioxide in the sample.

### BACKGROUND OF THE INVENTION

Rebreathers are life support devices that allow the user to have an extended oxygen supply with a small weight burden in comparison to compressed air. They are used for mine escape, submarine escape, fire fighting, diving, aviation, confined space entry applications, space missions, and other purposes. They have been in use since the 19^{th} century.

In the simplest form of rebreather, expelled breathing air containing elevated levels CO₂ from the respiratory processors of the user goes through a housing that contains a chemical scrubber that removes the carbon dioxide (CO₂) leaving the remaining oxygen and any trace gases present into a single or multiple flexible counterlungs. The scrubber material (usually Sodium Hydroxide, Calcium Hydroxide, or Lithium Hydroxide) scrubs the CO₂ to allow the reuse of the exhaled air and remaining oxygen. Oxygen is replenished, the user inhales the refreshed mix and the cycle is repeated. The gas stream path is referred to the breathing loop. Scrubbers can fail due to a number of reasons. They may be overbreathed by a user under stress, poor packing, poor design, failure to start the scrubber reaction, excess moisture, exhausted absorbents or others. Excess CO₂ has lead to numerous deaths of rebreather users in civilian and military applications.

Gasses from the scrubber are at an elevated temperature and saturated with water vapor. Water comes from the user as well as the exothermic reaction in the scrubber where a molecule of water is generated for each molecule of CO₂ is scrubbed. When the gas leaves the scrubber, it begins to cool down and water begins to condense on the cooler surfaces of the hoses, counterlung, and walls of CO₂ sample cells that are below the dewpoint of the gas in the breathing loop.

This is well understood by anyone versed in the art of rebreather use or design. This invention is particularly novel in that it utilizes the flow of dry oxygen, oxygen enriched air, and or dilution gases that are inherent to rebreathers through a membrane dryer prior to the detector without any moving parts or extra energy requirement removing enough moisture to keep the gas stream above the dew point through the sample chamber. Preferably, the flow through the dryer and sampler is induced by an aspirator but may be pump driven.

### PRIOR ART

Techniques for moisture control in Infrared CO₂ monitors have included pressurizing the gas to condense the water, collecting the water, and then reducing the gas pressure, heating the gas stream above the dew point, flowing the moisture laden stream through silica gel or other moisture removal materials. Because of energy demands or increased work of breathing issues, these have not been successful. None of these approaches have been successful in field rebreather devices.

### SUMMARY OF THE INVENTION

This invention allows a small lightweight portable CO₂ tester to be used in the breathing loop of the rebreather by lowering the dew point of the gas to prevent condensation within the walls of the sample chamber. It does not require any power except for the monitor as gas flow is provided by a combination of aspiration driven by constant or intermittent flow of oxygen or oxygen enriched gas used to replace oxygen used by the operator and the pressure face on a Pitot tube. An adequate flow rate for the sample gas is 50 CCs per minute to provide a response time in 30 seconds or less. CO₂ breakthrough is not instantaneous unless there is a flooding of the loop or other mechanical failure. The output of the CO₂ analyzer can be directed to a display, visual alarm, or audible alarm. Additional embodiments allow for extraction of the gas sample from the scrubber media to provide indication of the amount of scrubber that is unused. Other embodiments allow for pumps for the sample gas stream to decrease the dynamic response time.

### DESCRIPTIONS OF FIGURES

Figure One is the preferred embodiment of the invention where a sample of the saturated gas stream from the scrubber is extracted, dried to lower the dew point and conveyed through a CO₂ detection chamber and returned to the gas stream.

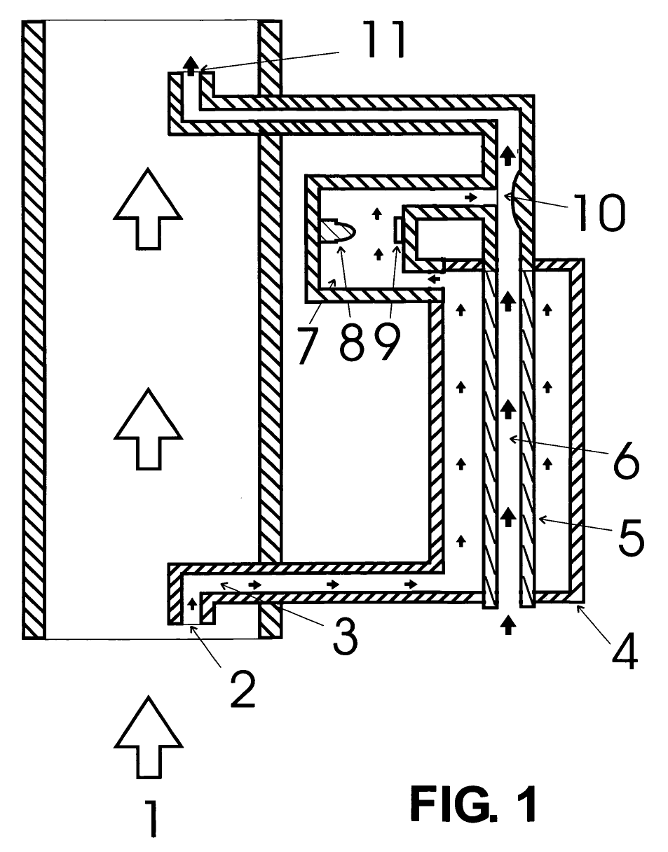

Referring to FIG. 1

Figure one is a cross sectional view of the principal components of the preferred embodiment. Saturated gas (1) exiting the scrubber flowing through the loop flows against the face (2) of a Pitot. A sample of the gas stream (3) enters the Pitot and flows through a moisture reduction chamber (4). Within the moisture reduction chamber (4) is a tube (5) with naflon walls. Flowing inside of the naflon wall tube (5) is a dry gas (6). In most rebreathers the dry gas (6) will be pure oxygen. The average flow rate of the dry gas (6) will be at least 900 CCs per minute as this is the resting metabolic oxygen demand although under working conditions it will be significantly higher. In other systems such as semiclosed circuit rebreathers the dry gas flow (6) may be Enriched Air or other gas at a low dew point flowing at even higher flow rates. Additional flow through the naflon wall tube (5) in rebreather systems with dilution gas supplies will be dry dilution gas.

Water vapor travels through the naflon tube walls from saturated (3) to unsaturated gas (6) streams through permeation distillation a manner well understood by those familiar with gas conditioning art. The dew point of the sample gas (3) is greatly reduced. The sample gas (3) with lowered dew point flows through a sample chamber (7) where the carbon dioxide concentration is analyzed. The preferred embodiment for analysis is by use of an infrared diode (8) and an infrared detector (9) by non dispersive infrared spectroscopy, a well documented and understood technique by those familiar with the art of gas analysis.

Exiting the sample chamber the sample gas (3) flow is enhanced in an aspirator (10) by the passing flow of the previously dry gas (6). The mixture of gasses (3) and (6) flow back into the breathing loop via downstream port of the Pitot (11).

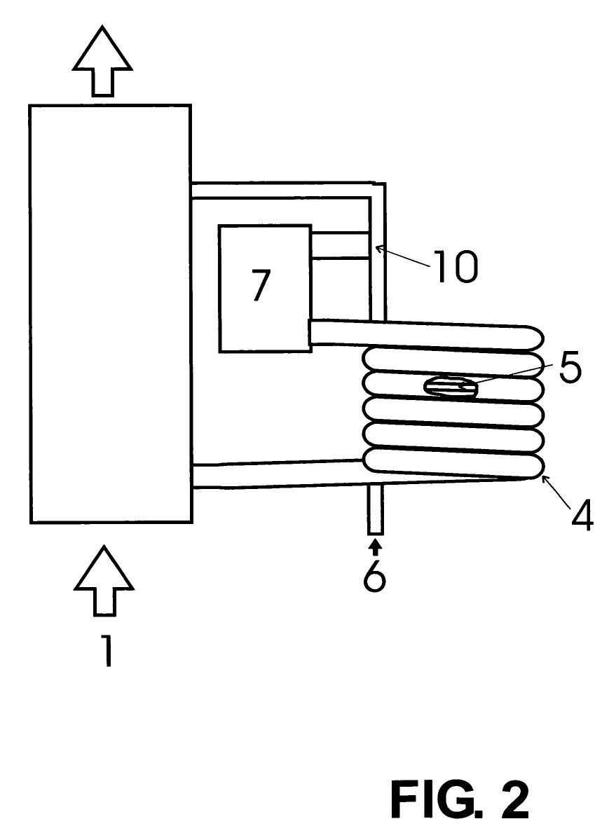

Referring to FIG. 2

In this embodiment said moisture reduction chamber (4) may be coiled to reduce length. Within the moisture reduction coil (12) the naflon tube (5) contains a dry gas that reduces the moisture from the sample of the breathing gas (1). The dried sample of gas enters a CO₂ monitor. Flow through the monitor is enhanced by an aspirator (10) powered by the flow of the dry gas. The mixture of sample gas and dry gas is returned to the breathing gas stream. The advantage of this embodiment is in the reduced size of the system.

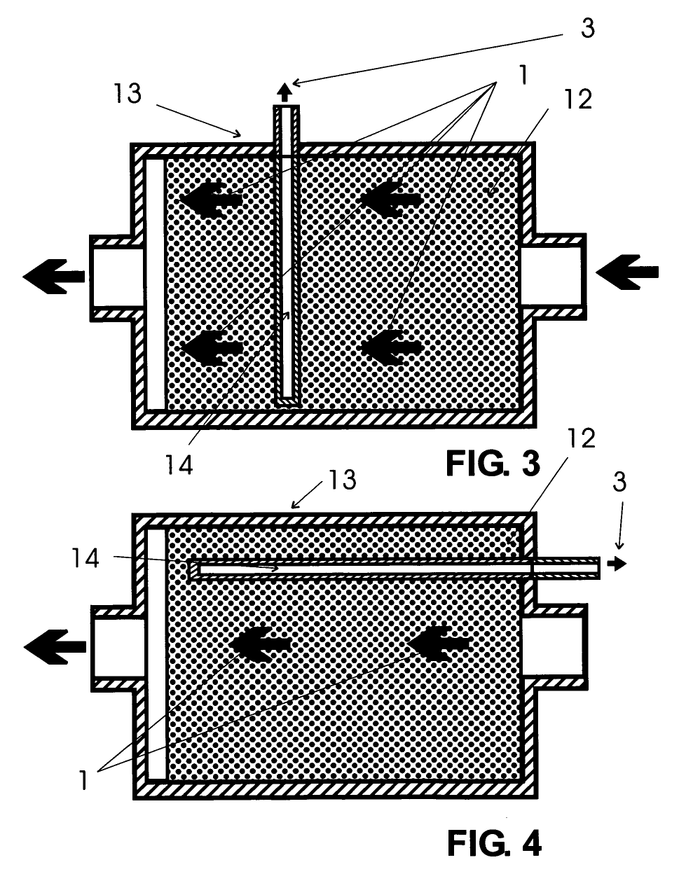

Referring to FIG. 3

Figure three is a cross sectional view of an axil scrubber with sample extraction tube.

In this embodiment a gas sample (3) is extracted from the saturated gasses (1) flowing through the scrubber media (12) of an axil scrubber (13). A porous sample tube (14) is installed perpendicular to the gas flow at any desired location along the scrubber (13). Placement of the porous tube (14) determines the percent of the scrubber media (12) exhausted when high levels of Carbon Dioxide are detected. This provides a safety factor for the user controlled by the location of the sample tube

Referring to FIG. 4

Figure four is a cross sectional view of an axil scrubber with sample extraction tube.

In this embodiment a gas sample (3) is extracted from the saturated gasses (1) flowing through the scrubber media (12) of an axil scrubber (13). A porous sample tube (14) is installed along the axis of the scrubber. As Carbon Dioxide penetrates further through the scrubber media, the percentage of Carbon Dioxide increases in the gas sample (3). The concentration of Carbon Dioxide can be used to calculate the relative amount of scrubber left.

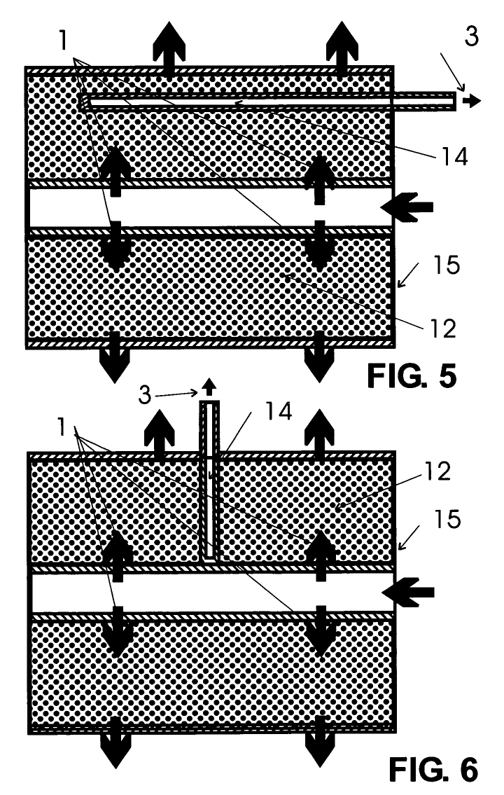

Referring to FIG. 5

Figure five is a cross sectional view of an radial scrubber with sample extraction tube. As those familiar with rebreather art recognize, in a radial scrubber the gasses travel either from the outside of the scrubber to the inside or from the inside to the outside.

In this embodiment the gas sample (3) is extracted from the saturated gasses (1) flowing through the scrubber media (12) of a radial scrubber (15). A porous sample tube (14) is installed perpendicular to the gas flow at any desired location along the scrubber. Placement determines what percent of the scrubber is exhausted when high levels of Carbon Dioxide is detected. This provides a safety factor for the user controlled by the location of the sample tube

Referring to FIG. 6

Figure six is a cross sectional view of an radial scrubber with sample extraction tube. As those familiar with rebreather art recognize, in a radial scrubber the gasses travel either from the outside of the scrubber to the inside or from the inside to the outside.

In this embodiment a porous sample tube (14) is installed along the direction of saturated gas (1) flow of the Radial (15) scrubber. As Carbon Dioxide penetrates further through the scrubber media, (12) the percentage of Carbon Dioxide increases in the gas sample (3). The concentration of Carbon Dioxide can be used to calculate the relative amount of scrubber left.

What is claimed is:

1. A compact Infrared CO₂ Monitor sample extraction and conditioning device having no moving parts comprising means for establishing a gas stream with a lowered dewpoint preventing condensation within the monitor utilizing the flow of dry supplemental oxygen on one side of a naflon or other suitable membrane to remove enough moisture from a sample stream extracted from the flowing rebreather users gas stream by a Pitot tube and aspiration.

2. A device as set forth in claim one where the flow is induced by the upstream and downstream pressure of a Pitot tube.

3. A device as set forth in claim one where the induced flow is induced by aspiration utilizing the make up oxygen or dilution gas flow to draw the sample through the system.

4. A device as set forth in claim one where the flow is induced by an air pump.

5. A device as set forth in claim one where the dry gas flows through a naflon membrane in the form of a tube that is within a tube containing the flowing sample gas.

6. A compact Infrared CO₂ Monitor device sample extraction and conditioning device having no moving parts comprising means for establishing a gas stream with a lowered dewpoint preventing condensation within the monitor by the means of the flow of dry dilution gas on one side of a naflon membrane to remove enough moisture from a sample stream extracted from the flowing rebreather users gas stream by a Pitot tube and aspiration.

7. A device as set forth in claim five where the induced flow is by the upstream and downstream pressure of a Pitot tube.

8. A device as set forth in claim five where the induced flow is driven by aspiration utilizing the dry gas to draw the sample through the system.

9. A device as set forth in claim five where the flow is induced by an air pump driven by the expansion and collapse of a counter lung.

10. A device as set forth in claim five where the flow is induced by a mechanical air pump.

11. A device as set forth in claim three where there are multiple sample ports within the body of the rebreather scrubber allowing determination of the amount of scrubber usage.

12. A porous tube installed in a scrubber for extraction of a sample for infrared analysis of Carbon Dioxide

13. A device as set forth in claim 12 where the porous tube is installed perpendicular to the flow of gasses in an axile scrubber.

14. A device as set forth in claim 12 where the porous tube is installed along the flow of gasses in an axile scrubber.

16. A device as set forth in claim 12 where the porous tube is installed perpendicular to the flow of gasses in a radial scrubber.

17. A device as set forth in claim 12 where the porous tube is installed along the flow of gasses in a radial scrubber.
